(19) United States
(12) Patent Application Publication
(10) Pub. No.: US 2026/0229090 A1
(43) Pub. Date: Aug. 6, 2026

(54) EXTERNAL BETTING TERMINAL, PROGRAM, AND BETTING SYSTEM

(71) Applicant: SEGA SAMMY HOLDINGS INC., Shinagawa-ku, Tokyo (JP)

(72) Inventors: Yuji SHIMADA, Tokyo (JP); Makoto KANEKO, Tokyo (JP); Osamu KATAYAMA, Tokyo (JP); Junichi NOZAWA, Tokyo (JP); Ryuta MATSUDA, Tokyo (JP); Naoki TAKADA, Tokyo (JP)

(21) Appl. No.: 19/150,188

(22) PCT Filed: Mar. 27, 2023
(86) PCT No.: PCT/JP2023/012279

§ 371 Date: Jul. 23, 2025

(51) Int. Cl. G07F 17/32; G06Q 50/34

(52) U.S. Cl. CPC G07F 17/3237; G06Q 50/34; G07F 17/322; G07F 17/3244; G07F 17/3293

(57) ABSTRACT

The present invention provides a mechanism that enables even a user who cannot be seated at a game table to participate in a table game while avoiding crowding in the area. An external betting terminal is provided in a gaming facility separately from a game table and can accept an external bet placed on a table game played at the game table. The external betting terminal is provided with a first accepting unit that accepts identification information of a user who places an external bet on a table game, a second accepting unit that accepts external betting information representing the content of the external bet, and a notification unit that provide a notification of acceptance status for the external bet based on the identification information of the user and the external betting information.

### CROSS-REFERENCE TO RELATED APPLICATIONS

This application is a national stage application of International Application No. PCT/JP2023/012279, filed on Mar. 27, 2023.

### FIELD

The present invention relates to an external betting terminal, program, and betting system for a game table.

### BACKGROUND

Table games, such as baccarat, blackjack, and Sic Bo, are widely played at game tables in gaming facilities including casinos (see, for example, Patent Literature 1). A game table has multiple user seating areas for users who participate in table games, but users who are not seated at the game table are also currently permitted to participate in such table games and place bets (wagers) next to any authorized users (i.e., users who are seated and participating in the games). Such an act of betting by non-seated users is referred to as “betting from outside the tables.”

### CITATION LIST

### Patent Literature

Patent Literature 1: Japanese Unexamined Patent Publication No. 2003-70956

### SUMMARY

### Technical Problem

However, given the recent social situation due to infectious diseases, an increasing number of gaming facilities are banning betting from outside the tables, which has easily led to many people gathering in the same area.

Although the ban on betting from outside the tables is a necessary measure to curb the spread of infectious diseases, the current situation is that casino revenues have declined as a result, and the facilities are facing a challenging operating environment.

### Solution to Problem

The present invention has been made in view of the circumstances described above and is directed to providing a mechanism that enables even a user who is not seated at a game table to participate in a table game while avoiding crowding in the area.

An external betting terminal according to an aspect of the present invention is an external betting terminal provided in a gaming facility separately from a game table and capable of accepting external bets placed on a table game played at the game table, and is provided with a first accepting unit configured to accept identification information of a user who places an external bet on the table game, a second accepting unit configured to accept external betting information representing content of the external bet, and a notification unit configured to provide a notification of acceptance status for the external bet based on the identification information of the user and the external betting information.

A program according to an aspect of the present invention causes a user terminal of a user who places an external bet via an external betting terminal for a table game played at a game table, when executed by the user terminal, to implement a first transmitting function for transmitting identification information of the user to the external betting terminal, an accepting function for accepting external betting information representing content of the external bet, a second transmitting function for transmitting the external betting information to the external betting terminal or a management server, and a receiving function for receiving credit information of the user from the management server, the credit information reflecting a payout result based on the external bet.

### Advantageous Effects of Invention

According to the present invention, even users who are not seated at a game table can participate in table games while avoiding crowding in the area.

### BRIEF DESCRIPTION OF DRAWINGS

FIG. 1 is a block diagram illustrating an example of a bet management system according to the present embodiment.

FIG. 2 is a diagram illustrating an example of operation screens displayed on an external betting application.

FIG. 3 is a diagram illustrating an example of the operation screens displayed on the external betting application.

FIG. 4 is a diagram illustrating an example of the operation screens displayed on the external betting application.

FIG. 5 is a diagram illustrating an example of the operation screens displayed on the external betting application.

FIG. 6 is a block diagram illustrating the main functional modules of the external betting terminal 300.

FIG. 7A is a sequence diagram illustrating a flow of processing when an external bet is placed.

FIG. 7B is a sequence diagram illustrating the flow of processing when an external bet is placed.

FIG. 8 is a diagram illustrating an example of an information transmission path for the bet management system.

FIG. 9 is a diagram illustrating an example of the information transmission path for the bet management system according to Modification 1.

FIG. 10 is a diagram illustrating an example of the information transmission path for the bet management system according to Modification 2.

FIG. 11A is a diagram illustrating an example of an integrated betting system.

FIG. 11B is a diagram illustrating an example of the integrated betting system.

### DESCRIPTION OF EMBODIMENTS

Preferred embodiments of the present invention are described herein with reference to the accompanying drawings. In each of the drawings, elements with the same symbol have the same or similar configuration.

### A. The Present Embodiment

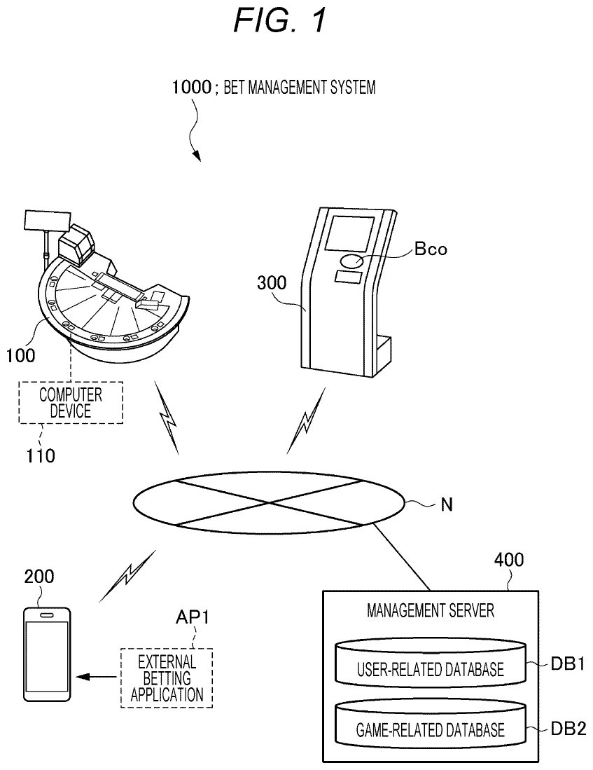

FIG. 1 is a block diagram illustrating an example of a bet management system 1000 according to the present embodiment.

The bet management system 1000 includes a game table 100, a user terminal 200, an external betting terminal 300, and a management server 400.

In addition to the betting area designated for the game table 100, the bet management system 1000 is provided with an external betting terminal 300 located within the gaming facility, which enables betting on the table games played at the game table 100. A user who is not seated at the game table 100 can use this external betting terminal 300 to place bets on desired table games. For convenience of description, placing bets using the external betting terminal 300 will be hereinafter referred to as “external betting.”

The game table 100, the user terminal 200, the external betting terminal 300, and the management server 400 are interconnected via a communication network N. Although FIG. 1 illustrates one each of the game table 100, the user terminal 200, and the external betting terminal 300, they can be provided in arbitrary numbers according to the number of users using the system 1000, and the like.

The communication network N includes a communication network that enables each terminal to transmit and receive information to and from other terminals. The communication network N may be, for example, the Internet, a LAN, a leased line, a telephone line, an in-house network, a mobile communication network, Bluetooth (registered trademark), WiFi (Wireless Fidelity), any other communication line, or a combination thereof, and may be wired or wireless.

### <Game Table 100>

The game table 100, for example, is a semicircular table provided with a play area for various table games, a betting area for users to bet chips, and the like. A plurality of betting areas are provided on a single game table 100, in accordance with the number of users who will be seated and participate in the table games (i.e., the number of user seating areas). It is noted that a “chip” is a virtual currency used by users in games, and each “chip” has a certain amount of credits.

The game table 100 is also equipped with a computer device 110 configured to manage the progress of table games and determine wins or losses of these games. For example, when the game table 100 is used for card games, such as baccarat or poker, the computer device 110 executes functions such as reading card information of playing cards (cards) dealt from a card shoe of the game table 100, determining the win or loss of the game based on the card information having been read, and transmitting the win or loss result to the management server 400 as win or loss information. In the present embodiment, it is assumed that the game table 100 automatically determines wins or losses of the games; however, a dealer or other personnel may determine wins or losses of the games and transmit the win or loss information from the game table 100. Some table games incorporate lottery drawings rather than determine wins or losses of the games. In the present application, the information representing the win or loss results of the games and the lottery results is collectively referred to as “win/loss information.”

### <User Terminal 200>

The user terminal 200 is a terminal used by a user who is not seated at the game table 100 to place external bets, which is configured by a smartphone, for example. However, the present invention is not limited to such a smartphone, and can be applied to any device capable of being carried by users, including a wearable device, a mobile phone, a tablet device, a personal computer (PC), a notebook PC, a hand-held computing device, or the like.

The user terminal 200 manages user IDs (e.g., identification information unique to the terminals) to uniquely identify users within the system 1000. Application software AP1 for placing external bets (hereinafter, the “external betting application”) is installed on the user terminal 200. The external betting application AP1 may be configured to be provided, for example, from an external server (not illustrated) via the communication network N, or it may be installed separately from various storage media (semiconductor memory, etc.).

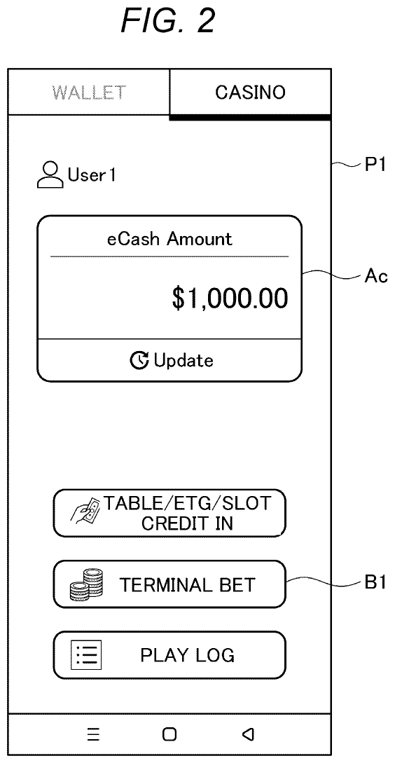

FIGS. 2 to 5 are diagrams illustrating examples of operation screens of the external betting application AP1 displayed on the user terminal 200.

As illustrated in FIG. 2, a first operation screen (home screen) P1 displays the holding status Ac of a dedicated substitute currency (e.g., electronic money, etc.; and hereinafter may simply be referred to as “credit”) capable of being used in the gaming facility, a terminal bet button B1 for placing external bets, and the like. By exchanging the user's own funds for the substitute currency in advance, the user can place external bets within the limits of the credit he or she holds. As an example, information representing the credit holding status of each user is centrally managed by the management server 400 as credit information. After the game ends, the payout results based on the external bets will be reflected in the credit information of each user.

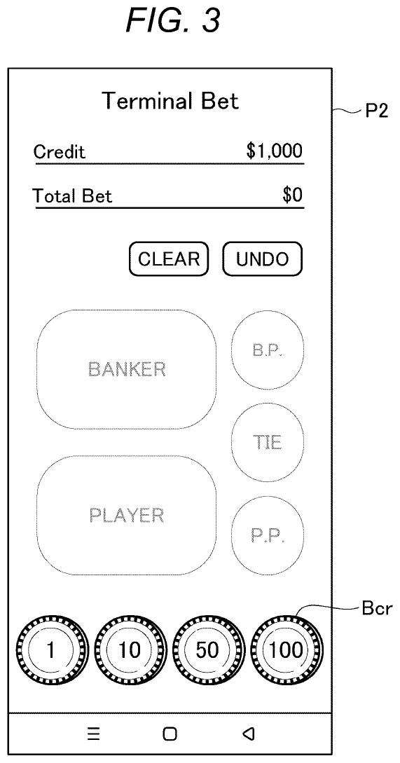

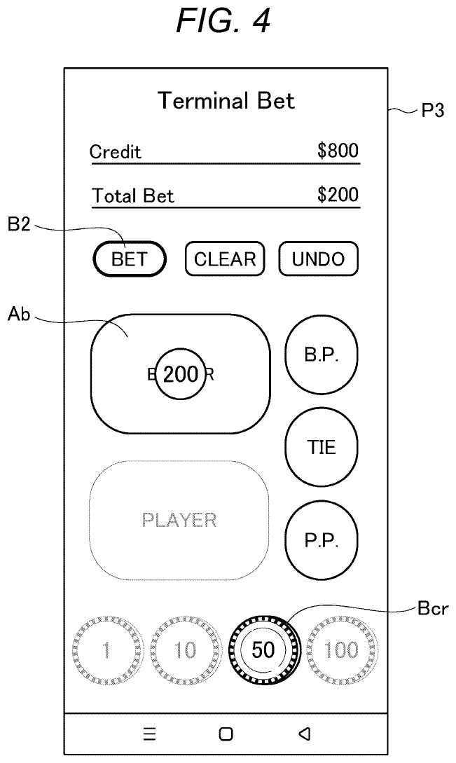

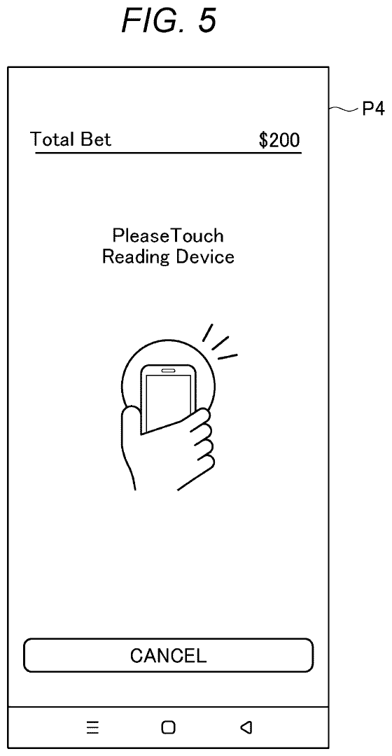

FIGS. 3 and 4 illustrate operation screens when a user places an external bet on a table game. It is assumed that baccarat is played as a table game on the second operation screen P2 and the third operation screen P3 illustrated in FIGS. 3 and 4. The user inputs external betting information including a betting area (i.e., an area where the user bets credits) and a bet amount, by operating the user terminal 200 appropriately. As an example, the user inputs external betting information by tapping a desired credit button (e.g., 100) Bcr, and then dragging and dropping it into a desired betting area (e.g., BANKER) Ab. After inputting the external betting information, the user presses the bet button B2. When such an operation is performed, a fourth operation screen P4 is displayed on the user terminal 200, as illustrated in FIG. 5, which prompts the user to hold the user terminal 200 over the external betting terminal 300. It is noted that the method of inputting external betting information is not intended to be limited to this particular example.

In response to the message on the fourth operation screen P4, the user then holds the user terminal 200 over the external betting terminal 300 within a bet acceptance time. When such an operation is performed, the user terminal 200 uses wireless communication (e.g., RFID, etc.) to transmit information, such as a user ID, to the external betting terminal 300. In the present embodiment, RFID is assumed as a form of wireless communication, but other wireless communications (such as Bluetooth (registered trademark) and IrDA (registered trademark) ) or wired communications may also be used.

### <External Betting Terminal 300>

The external betting terminal 300 is a terminal for users who are not seated to place external bets on a desired table game, for example, and is installed in the vicinity of each game table 100 in the gaming facility. In the present embodiment, it is assumed that one (or more) dedicated external betting terminal(s) 300 will be provided for each game table 100, but one (or more) external betting terminal(s) 300 may be shared by a plurality of the game tables 100.

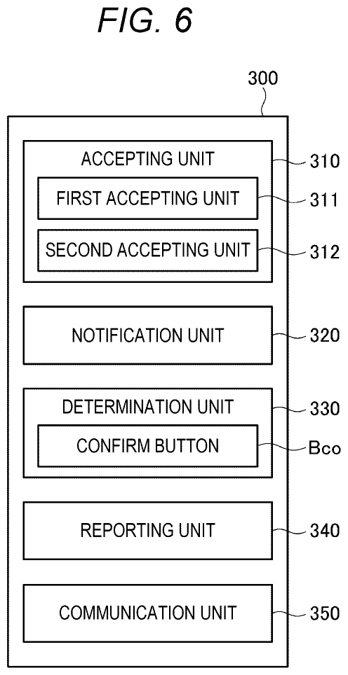

FIG. 6 is a block diagram illustrating the main functional modules of the external betting terminal 300.

The external betting terminal 300 includes an accepting unit 310, a notification unit 320, a determination unit 330, a reporting unit 340, and a communication unit 350. Each of these units can function when each hardware resource installed on the external betting terminal 300 cooperates with software installed on the external betting terminal 300.

The accepting unit 310 accepts various pieces of information necessary for placing external bets (e.g., a user ID and external betting information), and includes a first accepting unit 311 and a second accepting unit 312.

The first accepting unit 311 accepts, from the user terminal 200, a user ID and other identification information of the user who places an external bet, while the second accepting unit 312 accepts external betting information and others transmitted from the user terminal 200 via the management server 400.

The notification unit 320 is a display device, for example, which notifies the user of his or her acceptance status for the external bet (see below for details).

The determination unit 330 determines whether the input external betting information (i.e., the betting area and bet amount) should be confirmed. The external betting terminal 300 has a confirm button (confirmation button) Bco for final confirmation of the user's intention regarding the input external betting information. The confirm button Bco can be installed in any position, but may be installed below the display device (see FIG. 1), for example. Moreover, the confirm button Bco may be a hardware key or a software key. The user checks the content of the displayed external betting information and ensures that all the information is correct before pressing the confirm button Bco (input operation). When the determination unit 330 detects that the confirm button Bco has been pressed by the user, it determines that the acceptance of the external betting information should be confirmed.

When the determination unit 330 determines that the acceptance of the external betting information should be confirmed, the reporting unit 340 transmits an instruction to the management server 400 to confirm the acceptance of the external betting information.

The communication unit 350 transmits and receives various pieces of information to and from external equipment (the user terminal 200, the management server 400, etc.).

### <Management Server 400>

The management server 400 is configured by a server computer, for example, which manages various pieces of information related to external betting. Specifically, the management server 400 has a function for managing external betting information transmitted from the user terminal 200, a function for determining and managing payouts based on the external betting information and win/loss information transmitted from the game table 100, and a function for managing user information of each user (e.g., the user ID, name, age, gender, address, telephone number, email address, etc., as well as user's credit information), and the like.

The management server 400 is equipped with various databases, including a user-related database DB1 for storing user information, a game-related database DB2 for storing rule information necessary for the progress of each table game, win/loss information, and each user's external betting information (see FIG. 1), and the like.

The management server 400 may be implemented by a single server computer, but at least some of its functions may be implemented by a plurality of server computers interconnected via the communication network N.

The computer device 110 of the game table 100, the user terminal 200, the external betting terminal 300, and the management server 400 described above may each have the same hardware configuration as that of a general computer. For example, they may be equipped with a control unit comprising a CPU or the like, a storage device comprising a semiconductor memory, a hard disk or the like, a display device comprising a liquid crystal panel or the like, an input device with various types of controls, an output device comprising a speaker, a sound source chip or the like, and a communication device comprising various communication interfaces or the like. The operations of the bet management system 1000 in the case of placing external bets will be described in detail below with reference to the drawings.

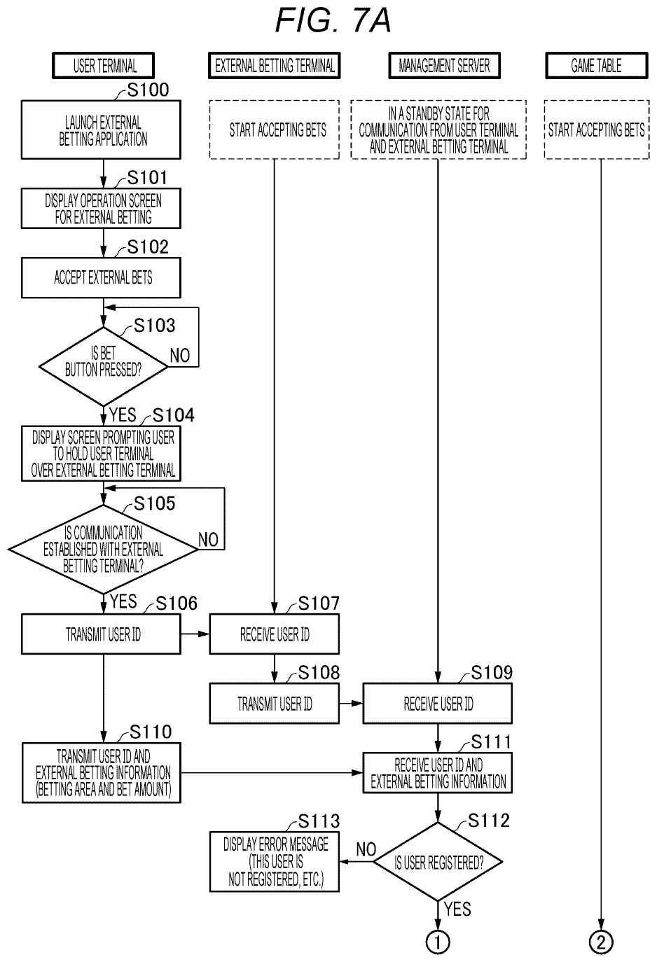

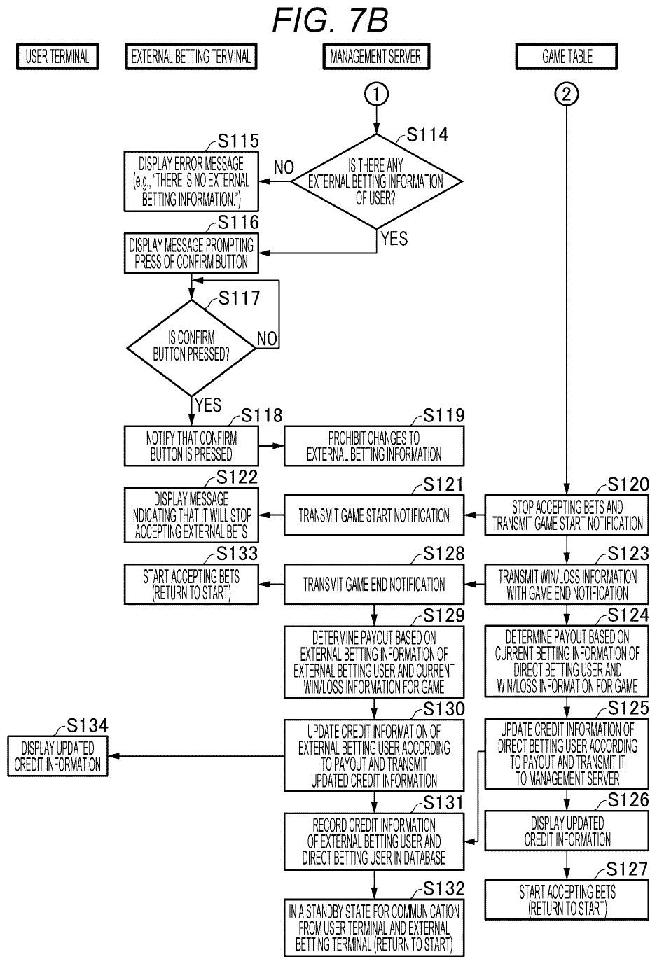

FIGS. 7A and 7B are sequence diagrams illustrating a flow of processing when an external bet is placed. Here, it is assumed that the user information of the user who is to place an external bet has already been registered in the management server 400. It is also assumed that the game table 100 and the external betting terminal 300 have started accepting bets, and the management server 400 is in a standby state for communication from the user terminal 200 and the external betting terminal 300.

First, the user terminal 200 launches the external betting application AP1 in response to a terminal operation executed by the user (step S100). In response to the launch of the external betting application AP1, the first operation screen P1 illustrated in FIG. 2 is displayed on the user terminal 200. The user taps the terminal bet button B1 displayed on the first operation screen P1.

When the user terminal 200 detects that the terminal bet button B1 has been tapped, it displays the second operation screen P2 illustrated in FIG. 3 and accepts the external bet (from step S101 to step S102).

The user operates the user terminal 200 to input external betting information (i.e., a betting area and bet amount). In response to the input of the external betting information, the user terminal 200 displays the third operation screen P3, as illustrated in FIG. 4, after the external betting information has been input.

Proceeding to step S103, the user terminal 200 detects whether the bet button B2 has been pressed by the user. If the bet button B2 has not been pressed (step S103; NO), the user terminal 200 repeats the processing of step S103. On the other hand, if the user terminal 200 detects that the bet button B2 has been pressed (step S103; YES), it displays the fourth operation screen P4 (step S104), which prompts the user to hold the user terminal 200 over the external betting terminal 300, as illustrated in FIG. 5. When the user then holds the user terminal 200 over the external betting terminal 300, wireless communication (e.g., RFID) will be established between the user terminal 200 and the external betting terminal 300.

Proceeding to step S105, the user terminal 200 determines whether communication has been established with the external betting terminal 300. If communication has not been established with the external betting terminal 300 (step S105; NO), the user terminal 200 repeats the processing of step S105. On the other hand, if communication has been established with the external betting terminal 300 (step S105; YES), the user terminal 200 reads out the user ID stored therein and transmits it to the external betting terminal 300 (step S106).

When the external betting terminal (first accepting unit) 300 receives the user ID from the user terminal 200, the terminal 300 transmits it to the management server 400 (from step S107 to step S108). The management server 400 receives the user ID from the external betting terminal 300 (step S109).

Meanwhile, the user terminal 200 transmits the external betting information (i.e., the betting area and bet amount) input by the user with the user ID to the management server 400 (step S110). The management server 400 receives the user ID and the external betting information from the user terminal 200 (step S111).

Proceeding to step S112, the management server 400 searches the user-related database DB1 using the user ID received from the user terminal 200 as a search key, and then determines whether the user is a registered user. The user-related database DB1 stores user information of users who have configured initial settings prior to using the system 1000. If the management server 400 determines that the user is not a registered user (i.e., a user authorized to use the system 1000) (step S112; NO), it instructs the external betting terminal 300 to display an error message regarding the user information. The external betting terminal 300 displays an error message regarding the user information (e.g., “This user (or the user terminal) is not registered”) on the display device in accordance with the instruction from the management server 400 (step S113).

On the other hand, if the management server 400 determines that the user is a registered user (step S112; YES), it references the game-related database DB2 and the like to determine whether there is any external betting information associated with the user ID of the user (step S114). If the management server 400 determines that there is no external betting information for the user (step S114; NO), it instructs the external betting terminal 300 to display an error message regarding the external betting information. The external betting terminal (notification unit) 300 displays an error message regarding the external betting information (e.g., “There is no external betting information”) on the display device in accordance with the instruction from the management server 400 (step S115).

On the other hand, if the management server 400 determines that there is external betting information for the user (step S114; YES), it instructs the external betting terminal 300 to transmit the external betting information and display a message prompting the user to press the confirm button Bco. When the external betting terminal (second accepting unit, notification unit) 300 receives an instruction from the management server 400 to display the external betting information and the message, it displays the received external betting information with a message prompting the user to press the confirm button Bco (e.g., “Please press the confirm button”) on the display device (step S116).

Proceeding to step S117, the external betting terminal 300 determines whether the confirm button Bco has been pressed. If the confirm button Bco has not been pressed (step S117; NO), the external betting terminal 300 repeats the processing of step S117. Subsequently, when the external betting terminal (notification unit) 300 determines that the confirm button Bco has been pressed (step S117; YES), it notifies the management server 400 that the confirm button Bco has been pressed (step S118).

When the management server 400 receives a notification from the external betting terminal 300 that the confirm button Bco has been pressed, it confirms the external betting information received from the user terminal 200 and prohibits any changes to the external betting information (i.e., changes to the betting area or bet amount) (step S119).

Meanwhile, when the game table 100 uses a timer (not shown) or other technique to detect that the time for accepting bets has elapsed, it lets the table game start and transmits a game start notification to the management server 400 (step S120). When the management server 400 receives the game start notification from the game table 100, it transmits the notification to the external betting terminal 300 (step S121). When the external betting terminal 300 receives the game start notification from the management server 400, it displays a message (e.g., “No More Bet”) on the display device, indicating that it will stop accepting external bets (step S122).

The game table 100 then manages the progress of the table game and determines the win or loss of the game. After determining the win or loss of the game, the game table 100 transmits the win/loss information indicating the win or loss result with a game end notification indicating the completion of the game to the management server 400 (step S123). Furthermore, the game table 100 executes the following processing for users (direct betting users) who place direct bets on the game table 100 without using the external betting terminal 300. In other words, according to the betting operation of the direct betting user, the game table 100 determines a payout based on the current betting information and the win/loss information for the game (step S124), updates the credit information according to the payout and transmits it to the management server 400 (step S125), and then displays the updated credit information on the display device of the game table 100 or the like (step S126). The game table 100 then starts accepting bets for the next game (step S127).

On the other hand, when the management server 400 receives the win/loss information with a game end notification from the game table 100, it transmits the game end notification to the external betting terminal 300 (step S128). Furthermore, the management server 400 determines a payout based on the external betting information of the user (external betting user) associated with the user ID and the win/loss information for the current game (step S129), and updates the credit information representing the credit holding status of the external betting user according to the determined payout. The management server 400 transmits the updated credit information to the user terminal 200 of the external betting user (step S130). Additionally, the management server 400 records the updated credit information of the external betting user and the credit information of the direct betting user received from the game table 100 in the user-related database DB1 (step S131). The management server 400 then returns to the standby state for communication from the user terminal 200 and the external betting terminal 300 (step S132).

Meanwhile, when the external betting terminal 300 receives a game end notification from the management server 400, it starts accepting external bets for the next game (step S133). In addition, when the user terminal 200 receives the updated credit information from the management server 400, it displays the information on the display device (step S134). By checking the user terminal 200, the user can ascertain the latest credit information reflecting a win or loss result of the current game and other relevant details.

As described above, according to the present embodiment, using the external betting terminal 300 provided in the gaming facility separately from the game table 100 enables users, even those who are unable to be seated at the game table, to place bets on table games while avoiding crowding in the area.

### B. Applications

The above described embodiments are intended to facilitate understanding of the present invention and are not intended to limit interpretation of the present invention. Each element included in the embodiments and the arrangement, material, conditions, shape, size, and the like of the element are not limited to those exemplarily presented but can be changed as appropriate. Additionally, configurations presented in different embodiments can be partially exchanged or combined.

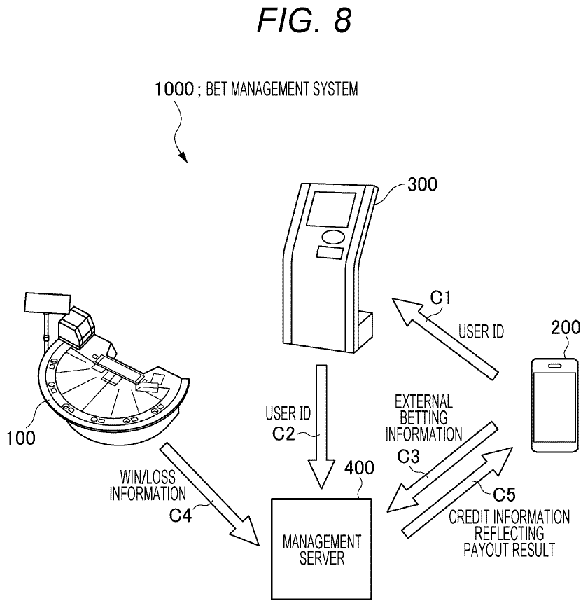

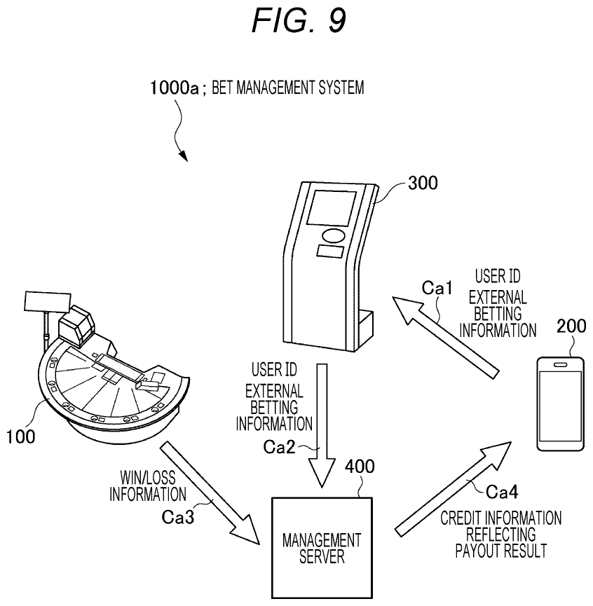

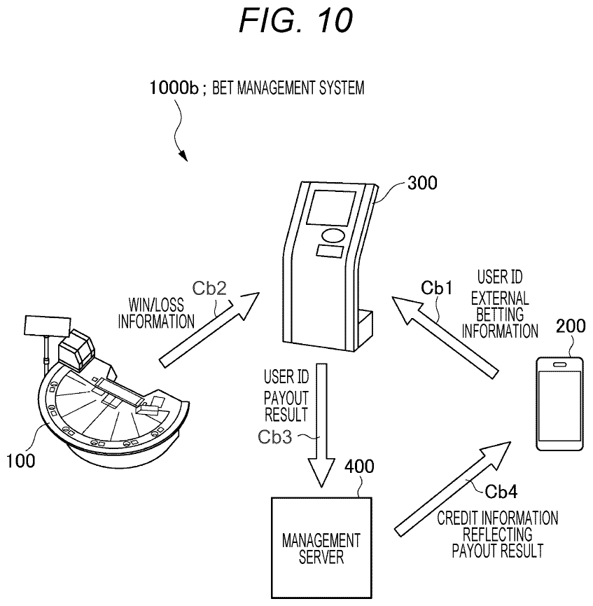

FIG. 8 illustrates an example of an information transmission path for the bet management system 1000 according to the present embodiment, FIG. 9 illustrates an example of the information transmission path for the bet management system 1000a according to Modification 1, and FIG. 10 illustrates an example of the information transmission path for the bet management system 1000b according to Modification 2.

### <Information Transmission Path of the Present Embodiment>

In the bet management system 1000 according to the present embodiment, the user terminal 200 transmits a user ID to the external betting terminal 300 (C1) first, and then the external betting terminal 300 transmits the user ID to the management server 400 (C2), as illustrated in FIG. 8. Next, the user terminal 200 transmits external betting information to the management server 400 (C3). When the game ends and the win or loss of the game is determined by the game table 100, the game table 100 transmits the win/loss information to the management server 400 (C4). The management server 400 determines a payout based on the external betting information associated with the user ID and the win/loss information, updates the credit information of the user according to the determined payout, and then transmits the updated credit information (i.e., credit information reflecting the payout result) to the user terminal (C5).

### <Information Transmission Path of Modification 1>

The information transmission path according to Modification 1 is characterized by the fact that external betting information is transmitted from the user terminal 200 to the management server 400 via the external betting terminal 300.

In the bet management system 1000a according to Modification 1, the user terminal 200 transmits a user ID and external betting information to the external betting terminal 300 (Ca1) first, and then the external betting terminal 300 transmits the user ID and external betting information to the management server 400 (Ca2), as illustrated in FIG. 9. When the game ends and the win or loss of the game is determined by the game table 100, the game table 100 transmits the win/loss information to the management server 400 (Ca3). The management server 400 determines a payout based on the external betting information associated with the user ID and the win/loss information, updates the credit information of the user according to the determined payout, and then transmits the updated credit information (i.e., credit information reflecting the payout result) to the user terminal (Ca4).

### <Information Transmission Path of Modification 2>

The information transmission path according to Modification 2 is characterized by the fact that a payout is determined by the external betting terminal 300, and the payout result is transmitted to the management server 400.

In the bet management system 1000b according to Modification 2, the user terminal 200 transmits a user ID and external betting information to the external betting terminal 300 (Cb1) first, as illustrated in FIG. 10. Next, when the game ends and the win or loss of the game is determined by the game table 100, the game table 100 transmits the win/loss information to the external betting terminal 300 (Cb2). The external betting terminal 300 determines a payout based on the external betting information associated with the user ID and the win/loss information, and notifies the management server 400 of the payout result with the user ID (Cb3). After updating the credit information of the user according to the notified payout result, the management server 400 transmits the updated credit information (i.e., credit information reflecting the payout result) to the user terminal 200 (Cb4).

As illustrated in each of the modifications described above, some of the functions of the management server 400 may be installed on the external betting terminal 300. It is obvious that the present invention is not intended to be limited to this configuration, and all the functions of the management server 400 may be installed on the external betting terminal 300.

### C. Others

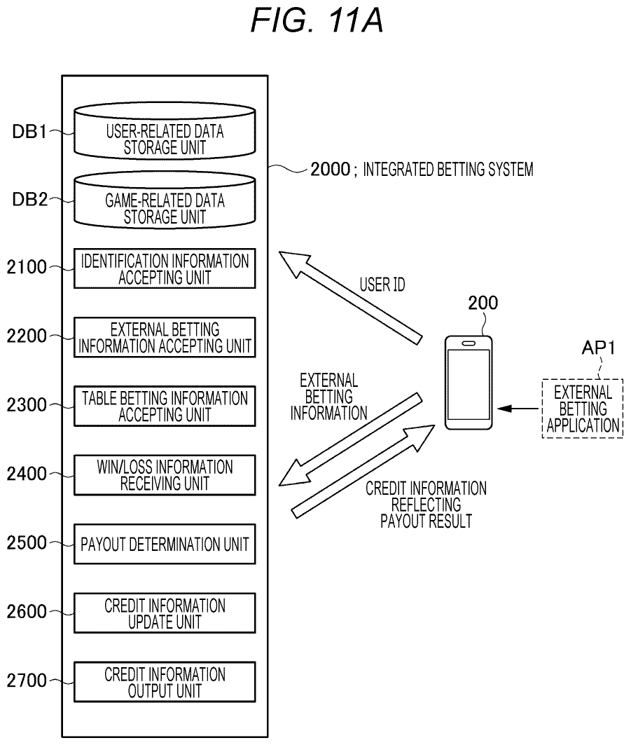

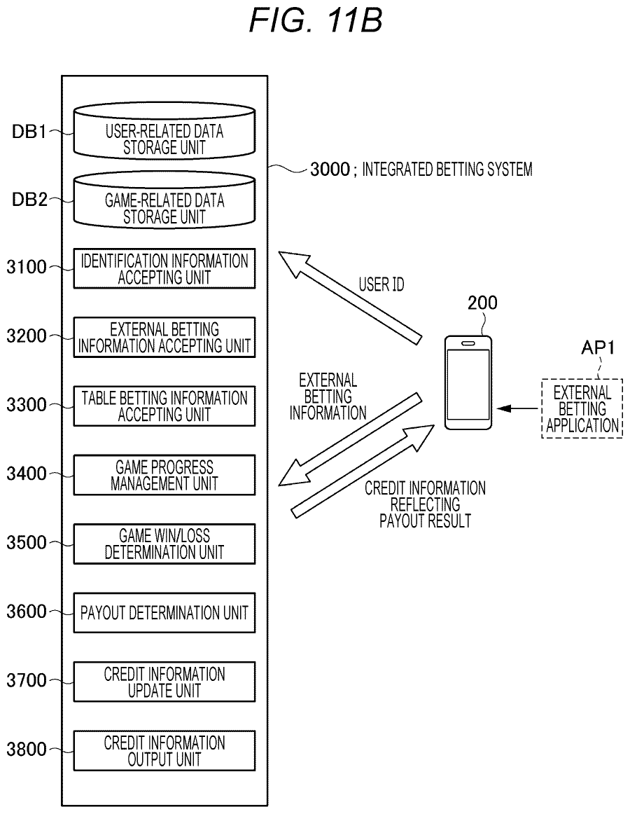

FIGS. 11A and 11B respectively illustrate an integrated betting system 2000 and an integrated betting system 3000, which incorporate some of the functions of the game table 100, the external betting terminal 300, and the management server 400.

The integrated betting system 2000 illustrated in FIG. 11A is a system incorporating some of the functions of the external betting terminal 300 and the management server 400.

The integrated betting system 2000 includes a user-related data storage unit DB1, a game-related data storage unit DB2, as well as an identification information accepting unit 2100, an external betting information accepting unit 2200, a table betting information accepting unit 2300, a win/loss information receiving unit 2400, a payout determination unit 2500, a credit information update unit 2600, and a credit information output unit 2700.

The identification information accepting unit 2100 accepts identification information (e.g., a user ID) of a user who places an external bet.

The external betting information accepting unit 2200 accepts external betting information, while the table betting information accepting unit 2300 accepts table betting information representing the content of the bet placed directly on the game table 100.

The win/loss information receiving unit 2400 receives win/loss information for a table game from the game table 100. The payout determination unit 2500 determines a payout based on the win/loss information. The credit information update unit 2600 updates the credit information of a user (an external betting user and/or a direct betting user) according to the payout. The credit information output unit 2700 stores the updated credit information in the user-related data storage unit DB1 or transmits it to the user terminal 200.

The integrated betting system 2000 may also include other functions provided in the external betting terminal 300 and the management server 400.

The integrated betting system 3000 illustrated in FIG. 11B incorporates some of the functions of the external betting terminal 300 and the game table 100.

The integrated betting system 3000 includes an identification information accepting unit 3100, an external betting information accepting unit 3200, a table betting information accepting unit 3300, a game progress management unit 3400, a game win/loss determination unit 3500, a payout determination unit 3600, a credit information update unit 3700 and a credit information output unit 3800.

The identification information accepting unit 3100 accepts identification information (e.g., a user ID) of a user who places an external bet.

The external betting information accepting unit 3200 accepts external betting information, while the table betting information accepting unit 3300 accepts table betting information representing the content of the bet placed directly on the game table 100.

The game progress management unit 3400 manages the progress of table games played at the game table 100.

The game win/loss determination unit 3500 reads the card information of the playing cards (cards) dealt from a card shoe of the game table 100, and determines the win or loss of the game based on the card information having been read.

The payout determination unit 3600 determines a payout based on the win/loss information. The credit information update unit 3700 updates the credit information of a user (an external betting user and/or a direct betting user) according to the payout. The credit information output unit 3800 transmits the updated credit information to the management server 400, user terminal 200, or the like.

The integrated betting system 3000 may also include other functions provided in the external betting terminal 300 and the game table 100.

It is noted that the integrated betting systems 2000 and 3000 described above are merely examples, and some (or all) of the configurations of each integrated betting system 2000 and 3000 may be combined to build a new integrated betting system.

1. An external betting terminal provided in a gaming facility separately from a game table and capable of accepting external bets placed on a table game played at the game table, the external betting terminal comprising:
a first accepting unit configured to accept identification information of a user who places an external bet on the table game;
a second accepting unit configured to accept external betting information representing content of the external bet; and
a notification unit configured to provide a notification of acceptance status for the external bet based on the identification information of the user and the external betting information.

2. The external betting terminal according to claim 1, further comprising:
a confirmation button configured to confirm the acceptance of the external betting information; and
a reporting unit configured to communicate an instruction to a management server to confirm the acceptance of the external betting information when an input operation of the confirmation button is detected.

3. The external betting terminal according to claim 2, wherein the external betting terminal starts accepting external bets for the next table game upon receiving a game end notification for the current table game from the management server.

4. The external betting terminal according to claim 2, wherein the second accepting unit accepts the external betting information directly from a terminal of the user or via the management server.

5. A program causing a user terminal of a user who places an external bet via an external betting terminal for a table game played at a game table, when executed by the user terminal, to implement:
a first transmitting function for transmitting identification information of the user to the external betting terminal;
an accepting function for accepting external betting information representing content of the external bet;
a second transmitting function for transmitting the external betting information to the external betting terminal or a management server; and
a receiving function for receiving credit information of the user from the management server, the credit information reflecting a payout result based on the external bet.

6. A betting system comprising:
an identification information accepting unit configured to accept identification information of a user who places an external bet on a table game played at a game table;
an external betting information accepting unit configured to accept external betting information representing content of the external bet;
a win/loss information receiving unit configured to receive win/loss information for the table game;
a payout determination unit configured to determine a payout based on the win/loss information;
a credit information update unit configured to update the credit information of the user according to the payout; and
a user-related data storage unit configured to store user-related data including the credit information of the user.

7. A betting system comprising:
an identification information accepting unit configured to accept identification information of a user who places an external bet on a table game played at a game table;
an external betting information accepting unit configured to accept external betting information representing content of the external bet;
a game progress management unit configured to manage progress of the table game;
a win/loss determination unit configured to determine win or loss of the table game;
a payout determination unit configured to determine a payout based on the win or loss of the table game;
a credit information update unit configured to update the credit information of the user according to the payout; and
a credit information output unit configured to output the updated credit information of the user.
